(19) United States
(12) Patent Application Publication
(10) Pub. No.: US 2016/0217751 A1
(43) Pub. Date: Jul. 28, 2016

(54) Remote Detection

(71) Applicant: NOKIA TECHNOLOGIES OY, Espo (FI)

(72) Inventor: Hannu LAHTI, Salo (FI)

(21) Appl. No.: 14/917,336

(22) PCT Filed: Sep. 1, 2014
(86) PCT No.: PCT/FI2014/050664

§ 371 Date: Mar. 8, 2016

(30) Foreign Application Priority Data
Sep. 17, 2013 (GB) 1316478.5

(51) Int. Cl. G09G 3/34; G06K 9/00; G09G 3/36

(52) U.S. Cl. CPC G09G 3/3406; G09G 3/3607; G06K 9/00201; G09G 2300/0452; G09G 2300/046

(57) ABSTRACT

An apparatus including a display panel, configured to be backlit by infrared light and visible light, including electronic circuitry configured to control transmission of visible light; and a plurality of discrete infrared light apertures configured to facilitate projection of a pattern of infrared light through the front face of the display panel for detecting an object in front of but not touching the front face of the display panel.

### TECHNOLOGICAL FIELD

Embodiments of the present invention relate to remote detection.

### BACKGROUND

It would be desirable to enable detection of an object when moved in front of an apparatus.

Some computer gaming platforms enable detection of an object when it is moved in front of the gaming console.

Microsoft Kinetic (Trade mark) uses hardware that is connected to the gaming console. This hardware uses an infrared projector and camera to enable the console to “see” the room in 3-D regardless of the lighting conditions.

### BRIEF SUMMARY

According to various, but not necessarily all, embodiments of the invention there is provided an apparatus comprising: a display panel, configured to be backlit by infrared light and visible light, comprising electronic circuitry configured to control transmission of visible light; and a plurality of discrete infrared light apertures configured to facilitate projection of a pattern of infrared light through a front face of the display panel for detecting an object in front of but not touching the front face of the display panel.

According to various, but not necessarily all, embodiments of the invention there is provided a method comprising: enabling projection of a pattern of infrared light through a display panel and beyond a front face of the display panel, the display panel being configured for controlled transmission of visible light; and enabling detection of an object in front of but not touching the front face of the display panel.

### BRIEF DESCRIPTION

For a better understanding of various examples that are useful for understanding the brief description, reference will now be made by way of example only to the accompanying drawings in which:

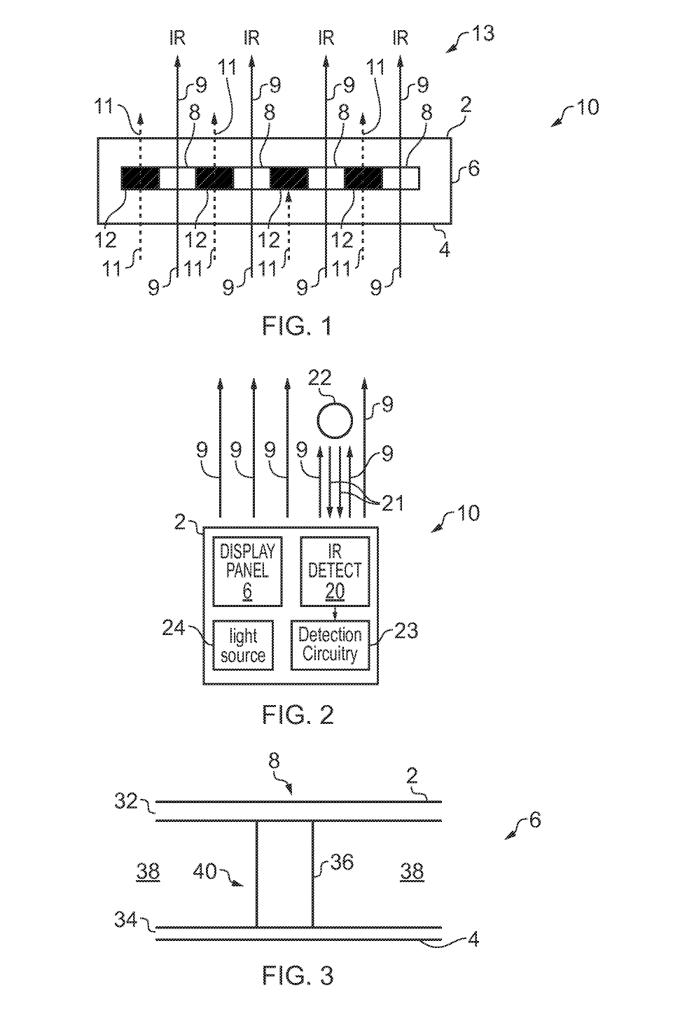

FIG. 1 illustrates an example of a display panel with a plurality of discrete infrared light apertures;

FIG. 2 illustrates an apparatus comprising the display panel;

FIG. 3 illustrates an example of a display panel comprising a lightguide;

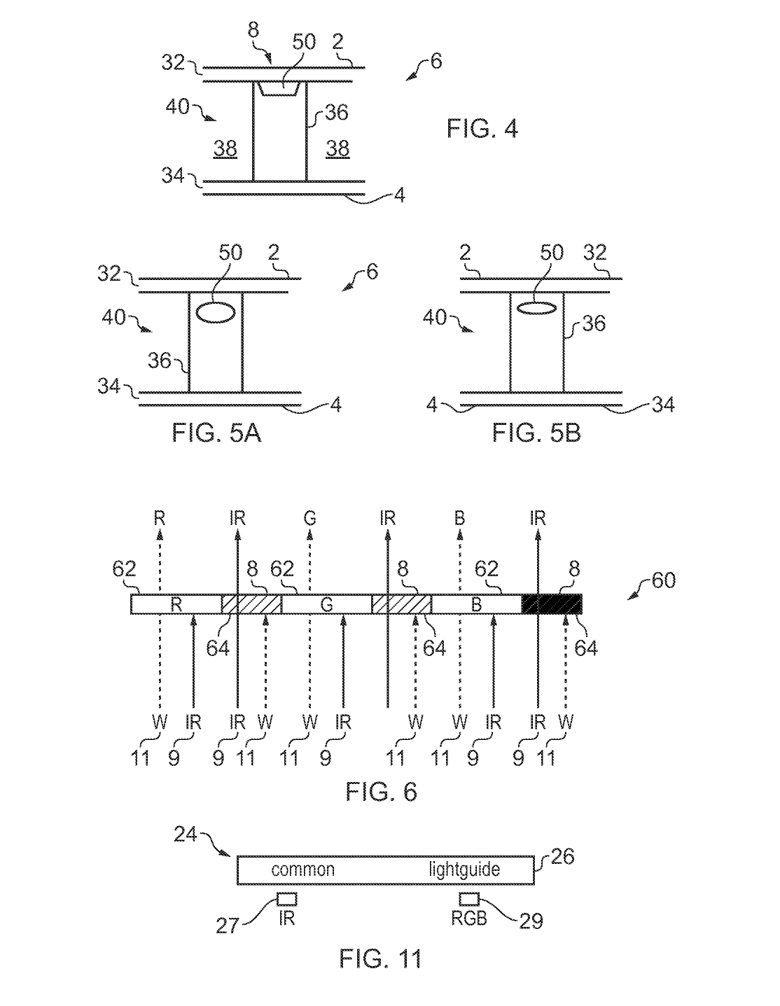

FIG. 4 illustrates an example of a display panel similar to that illustrated in FIG. 1, comprising a lightguide with optic;

FIGS. 5A and 5B illustrate an example of a display panel comprising a lightguide with configurable optic;

FIG. 6 illustrates an example where the infrared light apertures are located within a black matrix that physically separates and optically isolates color sub-pixels in a color filter;

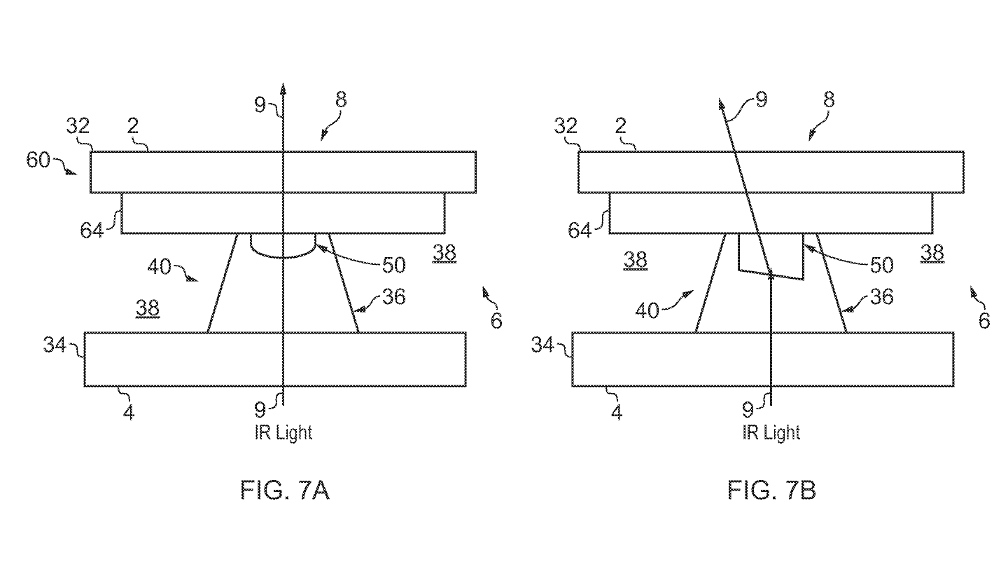

FIGS. 7A and 7B illustrate an example of a display panel that uses a color filter;

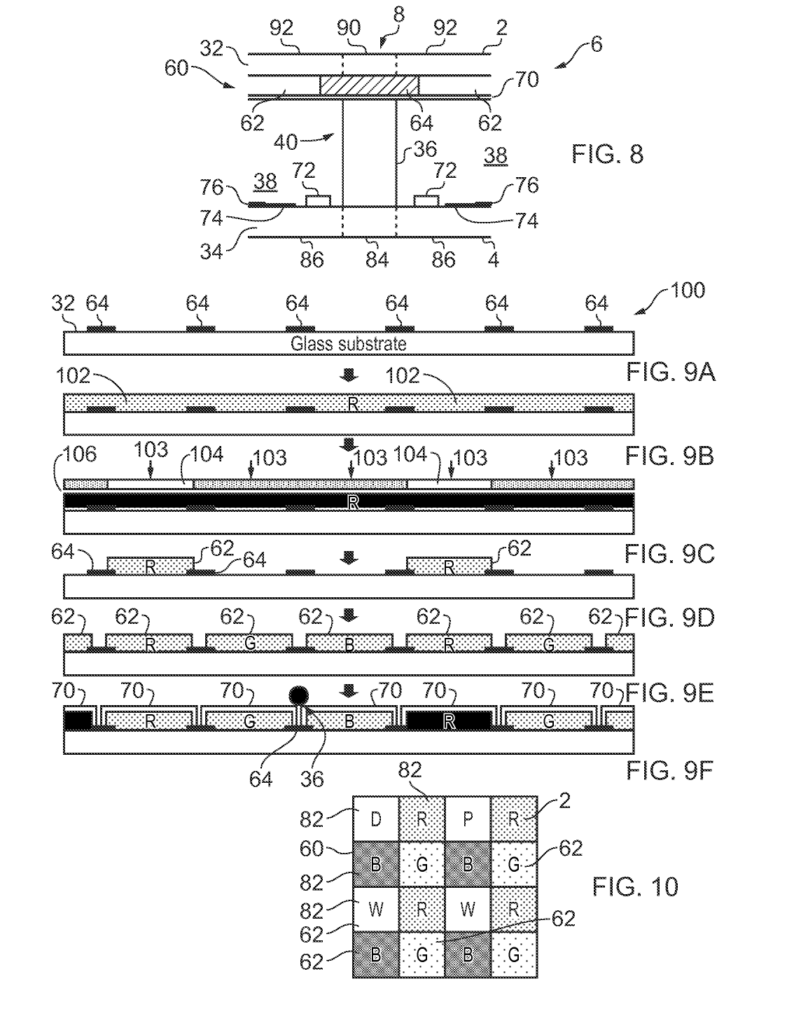

FIG. 8 illustrates an example of a display panel that uses a color filter;

FIGS. 9A to 9F illustrate an example of a method for manufacturing a component of a display panel;

FIG. 10 illustrates a color filter of a display panel that comprises red, green, blue and transparent (white) sub-pixels areas; and

FIG. 11 illustrates an example of a backlighting source configured to provide the visible light and the infrared light.

### DETAILED DESCRIPTION

The Figures illustrate an apparatus 10 comprising: a display panel 6, configured to be backlit by infrared light 9 and visible light 11, comprising: electronic circuitry 12 configured to control transmission of visible light 11 illuminate the display panel 6; and a plurality of discrete infrared light apertures 12 configured to facilitate projection of a pattern 13 of infrared light 9 through q front face 2 of the display panel 6 for detecting an object 22 in front of but not touching the front face 2 of the display panel 6.

FIG. 1 illustrates an example of an apparatus 10 for enabling detection of an object 22 in front of and not touching the front face 2 of the display panel 6. The apparatus 10 comprises a display panel 6, configured to be backlit by infrared light 9 and visible light 11.

The display panel 6 comprises: electronic circuitry 12 configured to control transmission of visible light 11 to a front face 2 of the display panel 6; and a plurality of discrete infrared light apertures 12 configured to facilitate projection of a pattern 13 of infrared light 9 beyond the front face 2 of the display panel 6 for detecting an object 22 in front of but not touching the front face 2 of the display panel 6.

The infrared light 9 may, for example, be in the frequency range 300 GHz to 400 THz. It may, for example be near infrared light, for example, in the frequency range 120 to 400 THz. The infrared light 9 may enter the display panel 6 via a rear face 4 of the display panel 6.

The visible light 11 may be in the frequency range 400-790 THz. The visible light 11 may also enter the display panel 6 via the rear face 4 of the display panel 6.

An infrared light aperture 8 is a limited area that has a much larger transmission coefficient, for infrared light, compared to a surrounding contiguous area. The limited area may be, but is not necessarily, a transparent window for infrared light. The surrounding area may be, but is not necessarily, opaque to infrared light.

Multiple infrared light apertures 8 are distributed in a pattern.

Each infrared light aperture 8 may produce a discrete ray of infrared (IR) light 9, when the display panel 6 is backlight by IR light 9. The rays of IR light form a pattern 13 corresponding to the pattern of the IR light apertures 8. On a surface at a distance from the display panel 6, the rays of IR light 11 form a pattern of IR light spots.

An IR light aperture 8 may be configured to preferentially output IR light compared to visible light. For example, each IR light aperture 8 may have a much larger transmission coefficient for infrared light 9 than for visible light 11. In some but not necessarily all examples, the infrared light apertures 8 are opaque to visible light 11 and the display panel 6 forms the pattern 13 only in the IR light spectrum.

The electronic circuitry 12 may be configured to control transmission of visible light 11 at different areas on the front face 2 of the display panel 6 independently. Each area corresponds to a pixel (or sub-pixel). The intensity of visible light emitted by a particular (sub-)pixel area is controlled by using the electronic circuitry 12 to control attenuation of visible light 11 through that particular (sub-)pixel area.

In some embodiments, a (sub-)pixel area comprises liquid crystal that is between two electrodes, which are between two polarisers. An electric control signal can be selectively applied to the electrodes to control locally the polarising effect of the liquid crystal. In this way, the transmission coefficient of each (sub-)pixel of the display panel 6 can be independently controlled. The amount of attenuation of visible light 11 passing through the display panel 6 is dependent upon the transmission coefficient.

The apparatus 10 may consist of only the display panel 6 or may consist of the display panel 6 and one or more additional components, for example as illustrated in FIG. 2.

As shown in FIG. 2, the apparatus 10 is configured to detect an object 22 in front of but not touching the front face 2 of the display panel 6. The display panel 6 projects a pattern 13 of infrared light 9 beyond the front face 2 of the display panel 6 for detecting an object 22. The projected IR light 9 is at least partially reflected, as reflected IR light 21, from the object 22. One or more IR detectors 20 detect the reflected IR light 21. The one or more detectors 20 provide outputs to the detection circuitry 23.

In some but not necessarily all embodiments, the IR light detector 20 may comprise one or more cameras at a front face of the apparatus 10 adjacent the front face 2 of the display panel 6. In this ‘camera’ arrangement, the apparatus 10 may be able to detect an object 22 in front of but not touching the front face 2 of the display panel 6, however, the apparatus 10 may be unable to detect accurately where an object 22 in front and touching the front face 2 of the display panel 6, touches the display panel 6.

The detection circuitry 23, in this camera embodiment, may be configured to: detect the presence of an object 22 by detecting IR light 21 at one or more cameras; and/or

detect a distance of an object 22 from the apparatus 10 by determining an intensity of IR light 21 at one or more cameras and/or by using an intermittently pulsed IR light 9 and triangulation based on time of flight to the respective cameras;

and/or

detect a size of the object 22 based on the size of the image captured by the respective camera(s).

In some but not necessarily all embodiments, the IR light detector 20 may comprise one or more IR sensors positioned as an array under the front face 2 of the display panel 6. In this example, the one or more IR sensors may be an integral part of the display panel 6 or, alternatively, placed under the display panel 6. In this arrangement, the apparatus 10 may be able to detect an object 22 in front of but not touching the front face 2 of the display panel 6 and also detect an object 22 in front and touching the front face 2 of the display panel 6.

The detection circuitry 23, in this sensor embodiment, may be configured to:

detect the presence of an object 22 by detecting IR light 21 at one or more IR sensors; and/or

detect a distance of an object 22 from the apparatus 10 by determining an intensity of IR light 21 at one or more IR sensors and/or by using an intermittently pulsed IR light 9 and a time of flight between transmission and detection; and/or

detect a size of the object 22 based on the number of IR sensors that detect reflected IR light 21.

As illustrated in FIG. 2, the apparatus 10 may additionally comprise a backlighting light source 24. The backlight source 24 provides the IR light 9 and may also provide the visible light 11.

An example of a backlighting source 24 configured to provide the visible light 11 and the IR light 9 is illustrated in FIG. 11. In this example, the backlighting source 24 comprises one or more visible light sources 29 and one or more IR light sources 27.

A visible light source 29 may, for example, comprise one or more light emitting diodes (LED). If white light is required, the visible light source 29 may comprise one or more white light LEDs , or alternatively one or more groups of red (R), green (G) and blue (B) light emitting diodes.

An IR light source 27 may, for example, comprise one or more IR light emitting diodes.

The visible light source(s) 29 and the IR light source(s) 27 may be configured to operate independently. Thus the IR light source(s) 27 may be operational when the visible light source(s) 29 are not operational.

The visible light source(s) 29 and the IR light source(s) 27 emit visible light 11 and IR light 9 respectively into a common lightguide 26. The common lightguide 26 is a lateral lightguide that extends under the rear face 4 of the display panel 6 and is used to transfer the visible light 11 and the IR light 9 to the display panel 6.

In some but not necessarily all embodiments the common lightguide 26 may be an integral part of the display panel 6.

The apparatus 10 may be solely transmissive. In this case, the backlighting source 29 is the only source of visible light 11. In other examples, the apparatus 10 may additionally or alternatively be transflective and the visible light 11 may be provided in addition or alternatively by reflecting ambient light that passes through the display panel 6.

The apparatus 10 may be any electronic apparatus that is required to display information on a display panel 6 and to detect a remote object 22. The apparatus 10 may, for example, be a personal computer, a display apparatus, a touch-screen apparatus, a television apparatus, a mobile personal electronic apparatus, a hand-portable electronic apparatus, or a mobile cellular telephone.

FIG. 3 illustrates an example of a display panel 6 similar to that illustrated in FIG. 1. It has the same functionality as the display panel 6 illustrated in FIG. 1 and similar references are used for similar features.

The display panel 6 is configured to be backlit by infrared light 9 and visible light 11. The display panel 6 comprises: electronic circuitry (not shown in FIG. 3) configured to control transmission of visible light (not shown in FIG. 3) to a front face 2 of the display panel 6. The display panel 6 also comprises a plurality of discrete infrared light apertures (not shown in FIG. 3) configured to facilitate projection of a pattern of received infrared light (not shown in FIG. 3) beyond the front face 2 of the display panel 6 for detecting an object in front of but not touching the front face 2 of the display panel 6.

The display panel 6 illustrated in FIG. 3 additionally comprises a front substrate 32, which defines the front face 2; a rear substrate 34, which defines the rear face 4, and a support structure 36 separating the front substrate 32 and the rear substrate 34.

The void 38 created between the front substrate 32 and the rear substrate 34 may comprise liquid crystal. The front substrate 32 and the rear substrate 34 may each provide an electrode for actuating the liquid crystal.

In this example, one or more of the IR light apertures 8 is aligned with a respective support structure 36. The respective support structures 36 are configured to operate as IR lightguides 40 which channel IR light 9 incident on the rear face 4 of the rear substrate 34 to the front face 2 of the front substrate 32.

The support structures 36 may be isolated supporting columns. The supporting columns may have lateral dimensions (parallel to the front and rear faces 2, 4) that are less than the distance between the front and rear faces 2,4. The separation between adjacent support structures 36 may be larger than the lateral dimensions of the support structures 36.

Thus at least some of the infrared light apertures 8 are associated with infrared lightguides 40 that provide channels for infrared light 9 in a direction towards the front face 2 of the display panel 6.

FIG. 4 illustrates an example of a display panel 6 similar to that illustrated in FIG. 3. However, this display panel 6 has one or more optics 50 associated with the IR light guides 40.

The optic may, for example, be formed adjacent the boundary between the support structure 36 and the front substrate 32. An optic may, for example, comprise a cavity within the support structure 36.

The purpose of the optic is to control how the IR light 9 passing through the IR light aperture 8 is projected. For example, the optic may direct the IR light 9 in a particular direction and/or the optic 50 may concentrate or focus the IR light 9.

The optic 50 may, for example use refraction or diffraction.

FIGS. 5A and 5B illustrates a particular example of the display panel 6 illustrated in FIG. 4. In this example, the optic 50 is electrically configurable.

In FIG. 5A, the optic 50 is in a non-actuated state and in FIG. 5B the optic 50 is in an actuated state.

When the optics 50 are in the non-actuated state, the plurality of lightguides 40 may cooperate to project a diffuse, continuous pattern of IR light 9. The IR light 9 projected from each IR light aperture 8 may overlap forming a spatially uniform IR light field. This may be suitable for detecting the presence of an object 22 in the projected IR light field.

When the optics 50 are in the actuated state, the plurality of lightguides 40 may cooperate to project distinct rays of IR light 9 that do not overlap from the IR light apertures 8. This spatially non-uniform light field may be suitable for identifying or disambiguating the object 22. For example, each infrared light aperture 8 may produce a discrete ray of infrared (IR) light 9 that form a pattern of IR light spots.

FIG. 6 illustrates an example where the IR light apertures 8 are located within a black matrix 64 that physically separates and optically isolates color sub-pixels 62 in a color filter 60.

The black matrix 64 is a material that is transparent to IR light and opaque black in the visible spectrum. It may, for example, be “IR transmittable ink” or other material used as filters for IR receivers.

In this example, each of the color sub-pixels 62 of the color filter 60 absorbs the IR light 9 and transmits either red(R), blue (B) or green (G) components of the visible light 11. In other embodiments, a white sub-pixel (W) may additionally be present. Each color sub-pixel 62 of the color filter 60 is opaque to the IR light 9.

In this example, the portion of the black matrix 64 corresponding to the IR light aperture 8 transmits some or all of the IR light 9 and absorbs the red(R), blue (B) and green (G) components of the visible light 11. The black matrix 64 is opaque to visible light 11.

FIG. 7A and 7B illustrate a display panel 6 (as described in FIG. 3, 4, or 5A, 5B) that uses a color filter 60 as described in FIG. 6. Similar references denote similar features. FIGS. 7A and 7B differ in that the IR light guides have different optics 50.

The front substrate 32 is a substrate for the color sub-pixels 62 of the color filter 60.

As better illustrated in FIG. 8, a common transparent electrode may cover the interior of the front substrate 32 including the color sub-pixels 62 of the color filter 60 and the black matrix material 64.

As better illustrated in FIG. 8, the rear substrate 34 may support an array of individually selectable sub-pixel electrodes 74 for controlling the sub-pixels of the display. The rear substrate 34 may additionally support, for each sub-pixel electrode 74, a thin film transistors 72 configured to control the sub-pixel electrode 74 and a capacitor 76 used to maintain a voltage at the sub-pixel electrode 74.

The IR light aperture 8 is defined, in this example, through the rear substrate 34, through lightguide 40 formed from a support structure 36, through black matrix material 64 and through the front substrate 32.

The lightguide 40 optionally comprises an optic or optics 50.

Referring to FIG. 8, the front substrate 32 may be entirely transparent to IR light 9 across its whole area or, alternatively, the front substrate 32 may be transparent to IR light 9 only in areas 90, aligned with the IR light apertures 8, and opaque to IR light 9 in other areas 92. The transparent areas 90 may be aligned with the lightguides 40 formed from the support structures 36, although the aperture of the transparent area 90 may be the same, smaller than or larger than the aperture defined by the lightguide 40.

The rear substrate 34 may be entirely transparent to IR light 9 across its whole area or, alternatively, the rear substrate 34 may be transparent to IR light 9 only in areas 84, aligned with the IR light apertures 8, and opaque to IR light 9 in other areas 86. The transparent areas 84 may be aligned with the lightguides 40 formed from the support structures 36, although the aperture of the transparent area 84 may be the same, smaller than or larger than the aperture defined by the lightguide 40.

FIGS. 9A to 9F illustrate an example of a method 100 for manufacturing a component of a display panel 6, as described above.

FIGS. 9A to 9F illustrate how the front components of the display panel 6 are manufactured. The front components comprise the front substrate 32, the black matrix material 64, the color pixels 62 of the color filter 60, the common electrode 70 and, finally, the support structure 36 that operates as a lightguide 40.

The manufacture of the display panel 6 is completed by placing liquid crystal material into voids formed between the front components of the display panel 6 and the rear components of the display panel 6 to form a display panel 6 as previously described and illustrated. The rear components may comprise a rear substrate 34, an array of sub-pixel electrodes 74 for controlling the sub-pixels of the display panel 6, and thin film transistors 72, capacitors and interconnect configured to provide and maintain a voltage at an individually selected sub-pixel electrode 74.

As illustrated in FIG. 9A, black matrix 64 is selectively formed on a substrate 32, which will become the front substrate 32 of the finished display panel 6. The substrate 32 may, for example, be a glass substrate.

The black matrix material 64 may, for example, consist of or comprise low reflectance chrome or resin. The black matrix is formed so that it will overlap the edges of the color sub-pixels 62 of the color filter 60 and maintain optical independence of the color sub-pixels 62.

As illustrated in FIG. 9B, a color-specific photoresist coating 102 is deposited over the black matrix material 64 and exposed portions of the substrate 32. This coating 102 will be used to form, simultaneously, all of the color sub-pixels 62 of the color filter for that specific color. In the illustrated example, the photoresist coating 102 is used to form the red (R) sub-pixels 62.

As illustrated in FIG. 9C, a photomask 106 is used to selectively expose the photoresist coating 102 to ultraviolet (UV) light 103. In this example, the photoresist is a positive photoresist and exposure to the light makes the photoresist coating 102 insoluble. Apertures 104 in the photoresist mask 106 define the areas of the R sub-pixels 62 and the edges of the apertures 104 are aligned to overlap the black matrix 64.

As illustrated in FIG. 9D, the unexposed portions of the photoresist coating 102 are removed to leave behind the sub-pixels 62, in this case, for the color red (R). The sub-pixels 62 are stabilized by curing.

The process illustrated in FIGS. 9B, 9C and 9D is then repeated, separately, for each of the remaining colors. In this case, this forms the blue (B) sub-pixels 62, followed by forming the green (G) sub-pixels 62. This completes formation of the color filter 60 as illustrated in FIG. 9E.

Next as illustrated in FIG. 9F, the common electrode 70 is formed over the sub-pixels 62 of the color filter 60 and over any exposed portions of the black matrix 64. The common electrode 70 is transparent to visible and IR light. It may, for example, be formed from indium tin oxide (ITO).

Support structures 36 are then positioned over the common electrode 70 in alignment with portions of the black matrix 64. Some or all of the support structures 36 may be a lightguide 40 for IR light and may comprise one or more optics 50.

FIG. 10 illustrates a color filter 60 of a display panel 6 that comprises red, green, blue and transparent (white) sub-pixels areas 82.

The Figure illustrates a front face 2 of the display panel and the sub-pixel areas 82 underlying the front face 2. In this example, some of the transparent sub-pixel areas 82 which would normally have been used for detecting white visible light are used for projecting IR light 9 and/or receiving reflected IR light 21.

The white sub-pixel areas 82 are arranged in a regular array at positions (2x+1, 2y−1), red sub-pixel areas 82 are arranged in a regular array at positions (2x+2, 2y−1), blue sub-pixel areas 82 are arranged in a regular array at positions (2x+1, 2y+2), green sub-pixel areas 82 are arranged in a regular array at positions (2x−1, 2y+2), where x, y are whole numbers.

Each of the red sub-pixel areas 82 is used as a red (R) color sub-pixel 62. Each of the green sub-pixel areas 82 is used as a green (G) color sub-pixel 62. Each of the blue sub-pixel areas 82 is used as a blue (B) sub-pixel 62.

Some of the transparent/white sub-pixel areas 82 are used as a white (W) color sub-pixel 62, however some of the transparent/white sub-pixel areas 82 are used for projecting IR light 9 and/or receiving reflected IR light 21. In the illustrated example, the transparent/white sub-pixel area 82 labelled D is used for detecting IR light 21 and the transparent/white sub-pixel area 82 labelled P is used for projecting IR light 21.

In the illustrated example, different sub-pixel areas 82 are used for projecting and detecting IR light.

Where a transparent sub-pixel area is used to project IR light 9, it is not necessary to use black matrix 64 that is transparent to IR light.

In some but not necessarily all embodiments, the display panel 6 (as described in

FIG. 3, 4, or 5A, 5B) may be a greyscale display rather than a flexible display. In such examples, a color filter 60 and black matrix 64 is not present.

In some but not necessarily all embodiments, the liquid crystal material that occupies the voids 38 may be a ferroelectric liquid crystal (FLC) or other liquid crystal. In this example, the support structure 36 that provides the lightguide 40 may be a lattice wall, which may be formed from polymer.

In some but not necessarily all embodiments, the display panel 6 (as described in

FIG. 3, 4, or 5A, 5B) may be flexible. The front substrate 32 and the rear substrate 34 may be flexible substrates, for example, plastic substrates.

As used here ‘module’ refers to a unit or apparatus that excludes certain parts/components that would be added by an end manufacturer or a user. The display panel 6 may be a module. The support structure 36 may be a module.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a display panel, configured to be backlit by infrared light and visible light, comprising
electronic circuitry configured to control transmission of visible light; and
a plurality of discrete infrared light apertures configured to facilitate projection of a pattern of infrared light through a front face of the display panel for detecting an object in front of but not touching the front face of the display panel.

2. An apparatus as claimed in claim 1, wherein the display panel is opaque to infrared light except at the infrared light apertures which provide infrared transparent windows.

3. An apparatus as claimed in claim 1, wherein the infrared light apertures are configured to preferentially output infrared light compared to visible light, and wherein the infrared light apertures are opaque to visible light.

4. (canceled)

5. An apparatus as claimed in claim 1, comprising a color filter, comprising color sub-pixels, configured to filter transmitted visible light.

6. An apparatus as claimed in claim 1, wherein at least some of the infrared light apertures are located within black matrix located between the color sub-pixels of the color filter, and wherein the color sub-pixels of the color filter absorb infrared light.

7. (canceled)

8. An apparatus as claimed in claim 1, wherein at least some of the infrared light apertures are located within transparent color sub-pixels of the color filter.

9. An apparatus as claimed in claim 1, wherein at least some of the infrared light apertures are associated with infrared lightguides that provide channels for infrared light in a direction towards the front face of the display panel, and wherein the infrared lightguides are provided by support structures that separate layers within the display panel.

10-11. (canceled)

12. An apparatus as claimed in claim 1, wherein at least some of the infrared light apertures are associated with optics for directing the infrared light.

13-14. (canceled)

15. An apparatus as claimed in claim 1, wherein the pattern of infrared light projected through the front face of the display panel is a pattern of IR light spots.

16. An apparatus as claimed in claim 1, wherein the display panel comprises a stack of multiple components each of which is transparent to IR light at least in the region of IR light apertures.

17. An apparatus as claimed in claim 1, comprising one or more infrared detecting devices.

18-19. (canceled)

20. An apparatus as claimed in claim 1, further comprising at least one infrared light emitter configured to backlight the display panel with infrared light.

21-22. (canceled)

23. A support structure configured to separate layers of a display panel, comprising material that is infrared light transparent and at least one optic.

24. An apparatus as claimed in claim 1 further comprising a support structure separating at least two layers of the display panel, where the support structure is configured as a lightguide for infrared light that facilitates projection of infrared light through the display panel.

25. A method comprising:
enabling projection of a pattern of infrared light through a display panel and beyond a front face of the display panel, the display panel being configured for controlled transmission of visible light; and
enabling detection of an object in front of but not touching the front face of the display panel.

26. A method as claimed in claim 25, comprising enabling projection of a pattern of infrared light through a display panel black matrix separating sub-pixel filters, and/or enabling projection of a pattern of infrared light through support structures that separate layers of the display panel and are configured as infrared light guides, and/or enabling projection of a pattern of infrared light through optics position between layers of the display panel.

27-28. (canceled)
